(19) United States
(12) Patent Application Publication
(10) Pub. No.: US 2013/0167587 A1
(43) Pub. Date: Jul. 4, 2013

(54) FEEDING DEVICE FOR GLASS MELTING INSTALLATIONS

(71) Applicants: Matthais Lindig, Ingelheim (DE); Erich Waltert, Erlenbach (DE)

(72) Inventors: Matthais Lindig, Ingelheim (DE); Erich Waltert, Erlenbach (DE)

(21) Appl. No.: 13/818,606

(22) PCT Filed: Aug. 31, 2011
(86) PCT No.: PCT/EP2011/065037

§ 371 Date: Feb. 22, 2013

(30) Foreign Application Priority Data
Aug. 31, 2010 (DE) 10 2010 035 893.2

(51) Int. Cl. C03B 3/00

(52) U.S. Cl. CPC C03B 3/00
USPC 65/29.16; 65/335; 65/160; 65/146; 65/136.2

(57) ABSTRACT

A feeding device for introducing particulate feedstock into glass melting installations, comprising pushing conveyors supplied by storage containers via guiding channels and directed onto the melt surface, and comprising a slide for advancing the feedstock on the melt surface. To largely avoid asymmetric material and temperature distribution and movements transverse to a feedstock transporting direction, and exposure of the installation mineral construction materials to changing thermal loads, a) at least three pushing conveyors are arranged alongside one another and, in the region of the guiding channels, are arranged so closely alongside one another that they can be supplied by a common distributing device, and are separated from one another in the intermediate region between two guiding channels by a dividing edge, and b) a linkage for the drive of a slide that can be introduced into the glass melt is led through the spacing between each two guiding channels.

The present invention relates to a feeding device for introducing particulate feedstock into glass melting installations having pushing conveyors that are supplied by storage containers via guide channels and are directed onto the melt surface, and having at least one slide for advancing the feedstock on the melt surface.

The term “pushing conveyor” refers to known transport and dosing devices in which transport takes place, in hollow bodies closed at the circumference, by conveyor screws or spirals or by a pushing piston, each connected to a drive, the drive shaft or linkage being led through a seal. In this way, sealing against dust distribution is ensured.

The term “dividing edge” refers to the upper end of a wedge-shaped element that divides a vertical material stream and can be fashioned with a narrow radius, or in the extreme case as an edge or fin.

Pushing conveyors are known in many different variants. On the one hand, they create a good seal against gas and dust, and on the other hand they form a kind of track for a slow further movement of the melt material on the melt surface. Thus, from GB 1 364 187 A it is known to orient two pushing conveyers at an angle of 90° to one another, and to operate them with differing, periodically fluctuating conveying capacities, in order to cause a kind of oscillating movement in the floating melt material. However, this prevents a constant and symmetrical distribution of the feedstock and of the melting rate. It is also known, for the acceleration and portioning of the feedstock, to use so-called slides that are not disclosed in GB 1 364 187 A but that are not capable of undoing the oscillating movements.

In WO 2010/136087 A1 (which does not have prior publication), it is proposed to feed glass melting furnaces, via shielded front parts—so-called “doghouses”—with flowable glass mixtures via a maximum of two transport devices, the feed to be introduced through a doghouse opening and pushed by a slide inside the doghouse in the direction toward a melt tank. The entry into the melt tank takes place through a relatively narrow opening. Here the doghouse is largely sealed in the two directions of flow relative to the atmosphere.

Therefore, the present invention is based on the object of supplying feedstock to a glass melting installation in such a way that an asymmetrical distribution of material and temperature, and movements transverse to the transport direction of the feedstock, are at least largely prevented, thus also preventing changing thermal loads on the mineral materials of the installation.

In the device indicated above, this object is achieved according to the present invention in that

a) at least three pushing conveyors are situated alongside one another, and in the area of their guide channels are situated so closely alongside one another that they can be supplied by a common distributor device, and are separated from one another in the intermediate region between two guide channels by a respective dividing edge, and that
b) through the spacing between each two guide channels there is led a respective linkage for driving a slide that can be introduced into the glass melt.

In this way the named object is completely achieved, namely the supplying of a glass melting installation with feedstock in such a way that an asymmetrical distribution of material and temperature, and movements transverse to the transport direction of feedstock, are at least largely prevented, thus also preventing changing thermal loads on the mineral materials of the installation. Through the portioning and the reinforced advance of the feedstock by the slide, back-flows of the melt into the feed area are also limited, and the isolation or portioning of the feedstock into floating islands is promoted, whose melting in the direction of the overall flow in the melt tank promotes the increase of the spacings. The overall system is nonetheless tight against dust, and overall there is a combinatorial effect.

In further embodiments of the device according to the present invention, it is particularly advantageous if, either individually or in combination:
the dividing edges are situated in a common horizontal plane,
the dividing edges are situated underneath a horizontal boundary edge that upwardly encloses a common feed opening,
above the feed opening there is situated a storage container that has in its floor area at teas outlet openings that are situated in the direction transverse to the dividing edges,
the cross-sections of the outlet openings can be controlled as a function of quantity,
the transport directions of the pushing conveyors are made so as to be adjustable,
the conveying capacities of the pushing conveyors are made so as to be adjustable,
in the area of the outlet openings there is situated an additional dosage device for additives, and/or
the slide is guided by angled linkages having a pivot bearing and a drive motor in such a way that the lower edge of the slide is immersed in the glass melt during its forward movement and can be pulled back above the glass melt and above the feedstock.

The present invention also relates to a method for introducing particulate feedstock into glass melting installations having pushing conveyors that are supplied by storage containers via guide channels and are directed onto the melt surface, and having at least one slide for the advance of the feedstock on the melt surface.

According to the present invention, the solution of the problem is achieved in the above-indicated method with the same advantages in that

a) at least three pushing conveyors are situated alongside one another, and in the area of their guide channels are situated so closely alongside one another that they are supplied by a common distributor device, and are separated from one another in the intermediate area between two guide channels by a respective dividing edge, and that
b) through the spacings between each two guide channels there is led a respective linkage for driving a slide that can be introduced into the glass melt.

In further embodiments of the method according to the present invention, it is particularly advantageous if, either individually or in combination:
feedstock is divided by dividing edges on the pushing conveyors that are situated in a common horizontal plane,
the feedstock is fed in the direction transverse to the dividing edges,
the cross-sections of the outlet openings are controlled as a function of quantity,
the conveying capacities of the pushing conveyors are controlled independently of one another,
an additional additive is dosed in the area of the outlet openings, and/or
the slide is guided by an angled linkage having a pivot bearing and a drive in such a way that the lower edge of the slide is immersed in the glass melt during its forward motion and is pulled back above the glass melt and above the feedstock.

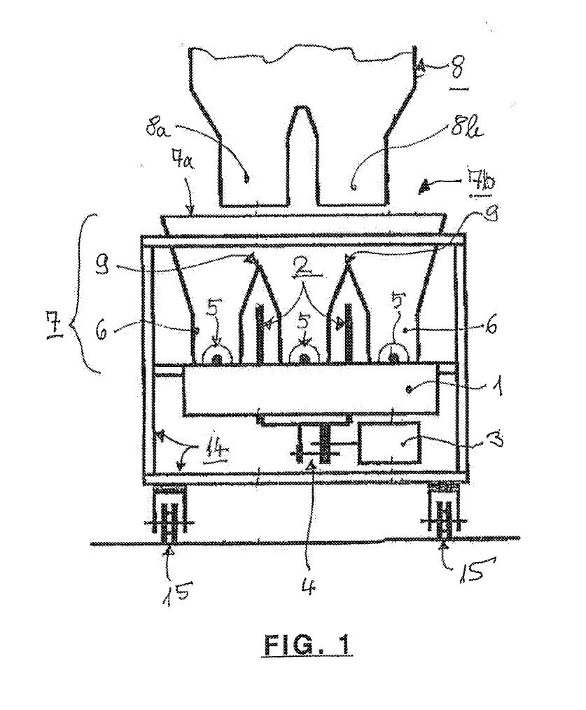

Exemplary embodiments of the subject matter of the present invention and their operation, and further advantages, are explained in more detail in the following on the basis of FIGS. 1 through 9.

The following are shown in predominantly schematic representations:

FIG. 1 shows a view from the furnace in the direction toward the feeding device,

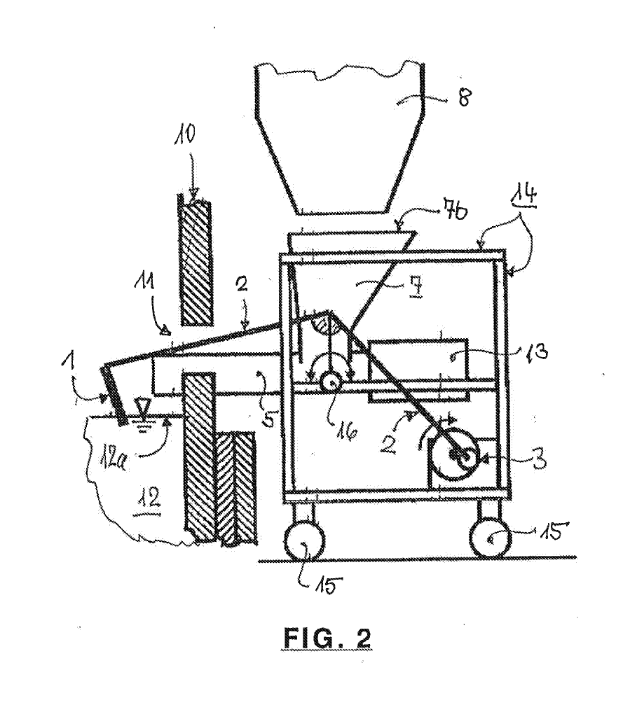

FIG. 2 shows a partially sectional side view of the subject matter of FIG. 1,

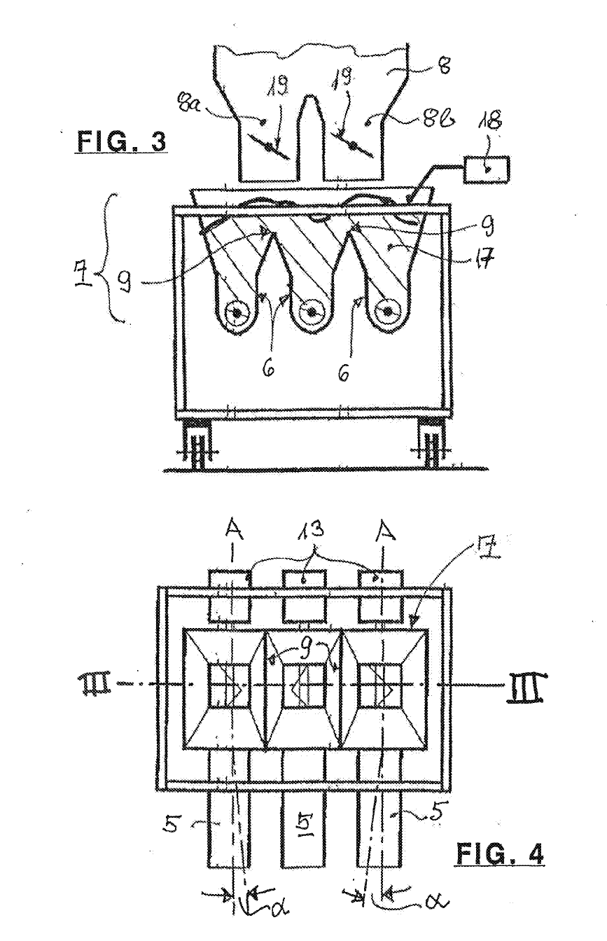

FIG. 3 shows a section through the subject matter of FIG. 4 [sic] in the vertical planes III-III in FIG. 4,

FIG. 4 shows a top view of the subject matter of FIG. 4 [sic], but without the storage container,

FIG. 5 shows a partially sectional side view of a device having an additional dosing device for additives,

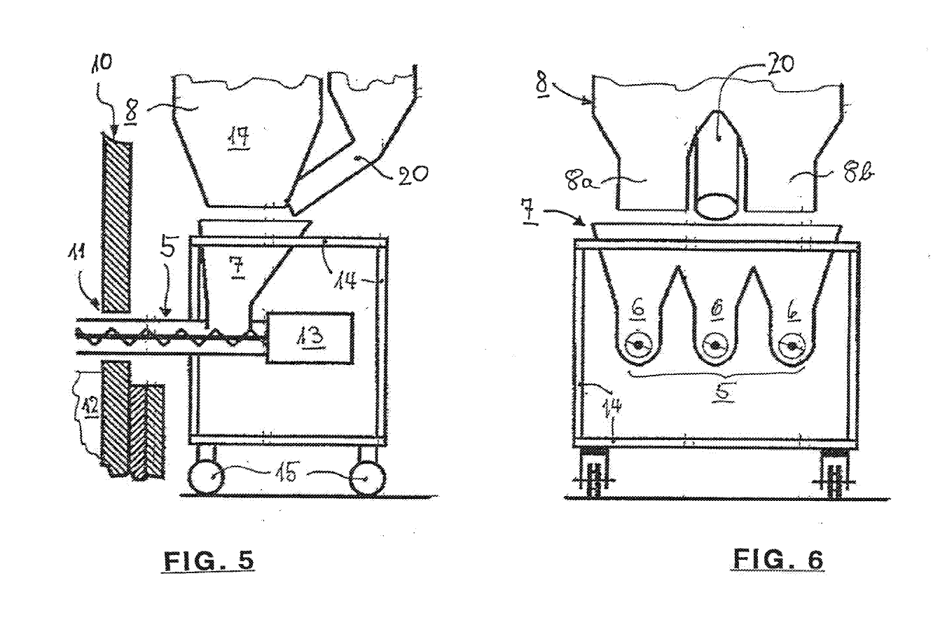

FIG. 6 shows an end view of a subject matter of FIG. 5 from the direction of the glass melting installation,

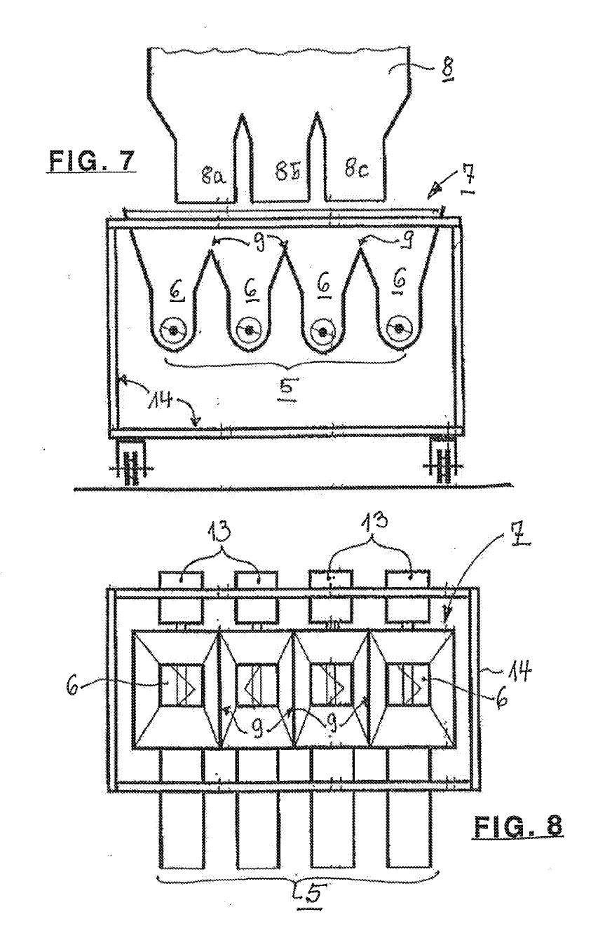

FIG. 7 shows an end view of a feeding device having four screw conveyors,

FIG. 8 shows a top view of the subject matter of FIG. 7, but without the storage container, and

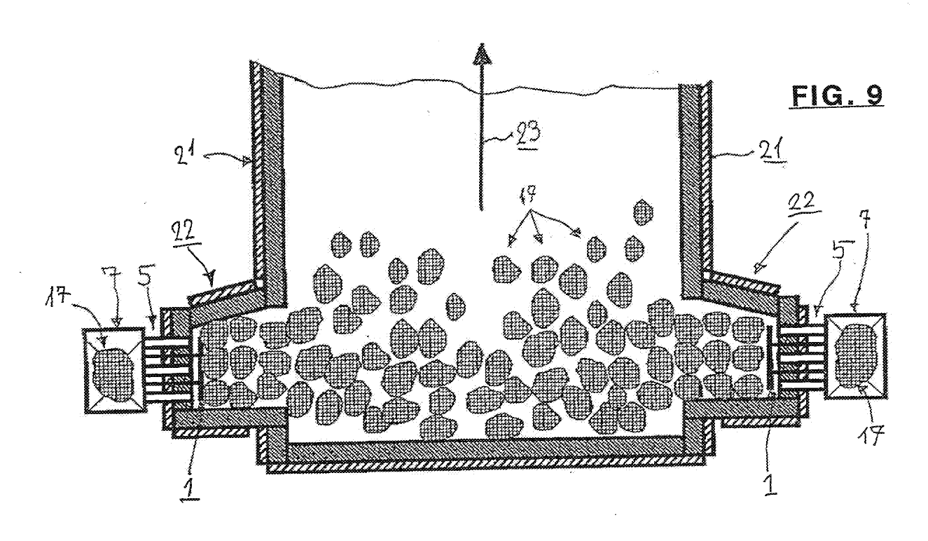

FIG. 9 shows a top view of a melt tank having two lateral front parts in which there are integrated subject matters according to the present invention.

FIG. 1 shows a view from the furnace in the direction toward the feeding device. At the front there is a slide 1 that is driven by a linkage 2 as further explained below. The drive takes place synchronously by a drive motor 3 and an eccentric transmission 4. The device has three pushing conveyors 5 whose axes run perpendicular to the plane of the drawing. They are surrounded by guide channels 6 that are situated on the underside of a common distributor device 7 having a horizontal boundary edge 7a that upwardly encloses a feed opening 7b. Above this feed opening 7b there is situated a storage container 8 that has in its floor area two outlet openings 8a and 8b. Between guide channels 6 there are situated dividing edges 9 in the form of ridges situated in a common horizontal plane.

Retaining the previously used reference characters, FIG. 2 shows a wall 10 of a glass melting installation having a feed opening 11. This wall can be an end wall, a side wall, and/or the wall of a front part behind which is retained a glass melt 12 having a melt surface 12a. Through feed opening 11 there extend both pushing conveyors 5 and slide 1, with its linkage 2. Each of the pushing conveyors 5 has its own drive 13. The overall system has a cuboidal frame 14 that is formed in a known manner by angled profiles that run at the edges, and is capable of moving on rollers 15. Linkage 2 also includes a pivot bearing 16 that, together with eccentric drive 3 on slide 1, produces a closed vertical circumferential path that produces a subdivision and a transport movement of the feedstock away from wall 10.

FIG. 3 shows the filling of guide channels 6 with feedstock 17, whose surface can be profiled throughout. The filling level is measured and controlled by a known filling state sensor 18. The output signal of this sensor is transmitted to positioning motors (not shown) by which control valves 19 in outlet openings 8a and 8b of storage container 8 can be adjusted according to requirements. Outlet openings 8a and 8b are situated centrically over dividing edges 9, which promotes the uniformity of the distribution.

Viewed together with FIG. 4, it will be seen that the spacings of pushing conveyors 5, or their guide channels 6, are also determined by their run-in areas, which have the shape of truncated pyramids standing on their heads, and are separated only as narrowly as possible by dividing edges 9. Here, three pushing conveyors 5 are shown, each of which is provided with a drive 13. Axes A of outer pushing conveyors 5 can converge in the exit direction at an angle α, which can be between 1 and 15°, so that the flow of feedstock 17 also converges correspondingly. This also holds for the other exemplary embodiments.

Retaining the above reference characters, FIGS. 5 and 6 show a partially sectional side view and an end view of a device having an additional dosing device 20 for additives, which can also include recycled material.

In analogy to FIGS. 3 and 4, FIGS. 7 and 9 show an expansion of the basic idea of the invention to include four pushing conveyors 5 and four guide channels 6. The number of outlet openings 8a and 8b has also been increased by one outlet opening 8c. Here as well, it will be seen that all three outlet openings 8a, 8b, and 8c are each directed symmetrically onto dividing edges 9, which is very favorable for the transverse distribution of feedstock 17.

FIG. 9 shows a top view of a melt tank 21 having two lateral front parts 22 in which there are integrated subject matters of the present invention each having three pushing conveyors 5. It will be seen that feedstock 17 is divided into relatively small “packets” or floating islands, whose size decreases in the direction of the overall flow (arrow 23), and whose spacing from one another increases. This greatly promotes the input of energy into the melt through radiation from above, and promotes the partial circulation of the melt underneath these islands, thus promoting the overall melting process.

### LIST OF REFERENCE CHARACTERS

1 slide
2 linkage
3 drive motor
4 eccentric transmission
5 pushing conveyor
6 guide channels
7 distributor device
7a boundary edge
7b feed opening
8 storage container
8a outlet opening
8b outlet opening
8c outlet opening
9 dividing edges
10 feed opening
11 glass melt
12a melt surface
13 drive
14 frame
15 rollers
16 pivot bearing
17 feedstock
18 level sensor
19 control valves
20 dosing device
21 melt tank
22 front parts
23 overall flow (arrow)
A, A-axes
α angle

1-16. (canceled)

17. A feeding device for introducing particulate feedstock into glass melting installations having pushing conveyors that are supplied by storage containers via guide channels and are directed onto a melt surface of the melting installation, and having at least one slide for the advance of the feedstock on the melt surface, comprising:
at least three pushing conveyors being situated alongside one another, and in the area of their guide channels being situated so closely alongside one another that they can be supplied by a common distributor device, and are separated from one another in an intermediate region between two guide channels by a respective dividing edge, and
through a spacing between each two guide channels there is led a respective linkage for driving a slide that can be introduced into the glass melt.

18. The feeding device as recited in claim 17, wherein the dividing edges are situated in a common horizontal plane.

19. The feeding device as recited in claim 17, wherein the dividing edges are situated with a spacing underneath a horizontal boundary edge that upwardly encloses a common feed opening.

20. The feeding device as recited in claim 19, wherein above the feed opening there is situated a storage container that has in its floor area at least two outlet openings that are situated in a direction transverse to the dividing edges.

21. The feeding device as recited in claim 20, wherein cross-sections of the outlet openings can be controlled as a function of quantity.

22. The feeding device as recited in claim 17, wherein the transport directions of the pushing conveyors are adjustable.

23. The feeding device as recited in claim 1 wherein the conveying capacities of the pushing conveyors are adjustable.

24. The feeding device as recited in claim 20, wherein in the region of the outlet openings there is situated an additional dosing device for additives.

25. The feeding device as recited in claim 17, wherein the slide is guided by an angled linkage having a pivot bearing and a drive motor in such a way that a lower edge of the slide is immersed in the glass melt during its forward movement, and the lower edge of the slide can be pulled back above the glass melt and above the feedstock.

26. A method for introducing particulate feedstock into glass melting installations having pushing conveyors that are supplied by storage containers via guide channels and are directed onto a melt surface of the installation, and having at least one slide for an advance of the feedstock on the melt surface, comprising the steps
situating at least three pushing conveyors alongside one another, and in the area of their guide channels, situating them so closely alongside one another that they are supplied by a common distributor device, and are separated from one another in the intermediate area between two guide channels by a respective dividing edge, and
leading a respective linkage for driving a slide that can be introduced into the glass melt through a spacing between each two guide channels.

27. The method as recited in claim 26, including dividing the feedstock by dividing edges on the pushing conveyors that are situated in a common horizontal plane.

28. The method as recited in claim 26, including feeding the feedstock in a direction transverse to the dividing edges.

29. The method as recited in claim 26, including controlling cross-sections of the outlet openings as a function of quantity.

30. The method as recited in claim 26, including controlling conveying capacities of the pushing conveyors independently of one another.

31. The method as recited in claim 26, including feeding an additional additive in the region of the outlet openings.

32. The method as recited in claim 10, including guiding the slide by an angled linkage having a pivot bearing and a drive in such a way that a lower edge of the slide is immersed in the glass melt during its forward movement, and the lower edge is pulled hack above the glass melt and above the feedstock.
